(19) United States
(12) Patent Application Publication
(10) Pub. No.: US 2011/0210676 A1
(43) Pub. Date: Sep. 1, 2011

(54) Public lighting device with high energetic efficiency

(75) Inventor: Gian Pietro Beghelli, Monteveglio (BOLOGNA) (IT)

(73) Assignee: BEGHELLI S.p.A., Monteveglio (BO) (IT)

(21) Appl. No.: 12/930,114

(22) Filed: Dec. 28, 2010

(30) Foreign Application Priority Data
Jan. 27, 2010 (IT) VI2010A000013

(51) Int. Cl. H05B 37/02; F21V 7/00

(52) U.S. Cl. 315/185 R; 362/235

(57) ABSTRACT

Public lighting device with high energetic efficiency, including a casing (10, 12) for containing light sources, suitable to be connected with a support element, wherein the casing (10, 12) comprises a emitting device (13) of LEDs (24) light radiation; in particular, the emitting device (13) of light radiation comprises a base plate (17), made of conductive material, onto which a printed circuit board (20) of control and management of a series of power-emitting LEDs (24), a series of longitudinal mirrors or reflectors (21), which develop on planes parallel each other and substantially orthogonal to the plane towards which the light radiation is directed, and a series of transverse mirrors or reflectors (22), which develop on planes parallel each other and substantially orthogonal to the development plans of the longitudinal mirrors or reflectors (21), are mounted. In addition, finned heat dissipators (19), which are contained inside the containment casing (10, 12) and to which respective slits or cracks (11) made in the aforesaid containment casing (10, 12) correspond, are connected with the base plate (17).

The present invention, generally, relates to a public lighting device with high energetic efficiency.

More specifically, the invention concerns a street lamp or Chinese lantern or lighthouse, which can be used for street LED lighting with high light efficiency.

The street lamps and/or lighthouses for street lighting (the so-called “street armour”) generally used so far include a lighting unit, normally placed at the top of a support pole and inserted into a lamp holder that can take various aesthetic configurations.

The aforesaid lighting unit includes one or more light lamps, each electrically connected with the respective lamp holder, suitable to project light downwardly, on the carriageway.

Although such systems are traditionally and widely used, they have some drawbacks, the first of which relating to the very low lighting and/or energetic efficiency.

In particular, it would be very convenient to have a street lamp or lighthouse, suitable to ensure a low environmental impact, reduced electricity consumption, and, at the same time, a good lighting even in conditions of poor visibility.

Within the above requirements, purpose of the present invention is, therefore, to create a public lighting device with high energetic efficiency, which allows to get a very high lighting efficiency, compared to the prior art, thereby reducing electricity consumption for its power, compared to the conventional incandescent lamps.

Another purpose of the present invention is to provide a public lighting device with high energetic efficiency, which is extremely reliable over time, efficient and functional for each need, as well as easy and quick to be mounted and inexpensive to be produced. Further purpose of the present invention is to provide a public lighting device with high energetic efficiency, which also allows to make visible the road surface and edge even in conditions of poor visibility. These and other purposes, according to the present invention, are achieved by implementing a public lighting device with high energetic efficiency, according to the attached claim 1.

Further embodiments of detail are described in the subsequent dependent claims.

Advantageously, the invention refers to the intelligent operation of a “street armour” or “street lighting”, which can be used in particular for street lighting and uses, as light source, a power LED emitter module with integral optics and dissipater, in order to guarantee a low environmental impact, due to the lower electricity consumption necessary for supplying the LED, compared to the conventional incandescent gas lamps.

The public LED lighting device, object of the invention, also includes a radio-controlled electronic feeder, any accessory sensors for measuring traffic conditions and/or environmental parameters and a containment and protection casing or envelope.

The following table summarizes the base features and photometric performances of the public lighting device in accordance with the present invention:

| Lamp type | 72 LED | 54 LED | 46 LED |
|---|---|---|---|
| Net flux | 7.040 lumen | 5.285 lumen | 4.480 lumen |
| Absorbed electric power | 89 W | 67 W | 58 W |
| Energetic device efficiency | 79 lumen/W | 79 lumen/W | 77 lumen/W |
| Net saving power compared | 49% | 62% | 67% |
| to a 175 W lamp with | | | |
| ferromagnetic feeder | | | |
| Saved energy every year | 360.99 kWh | 453.33 kWh | 491.11 kWh |
| compared to the 175 W | | | |
| lamp with | | | |
| ferromagnetic feeder | | | |
| (full power | | | |
| for 11.5 hours per day) | | | |

Additional features and advantages of a public lighting device with high energetic efficiency, according to the invention, will be more evident from the description that follows, relating to a preferred and illustrative, but not limiting, embodiment thereof and the appended drawings, in which:

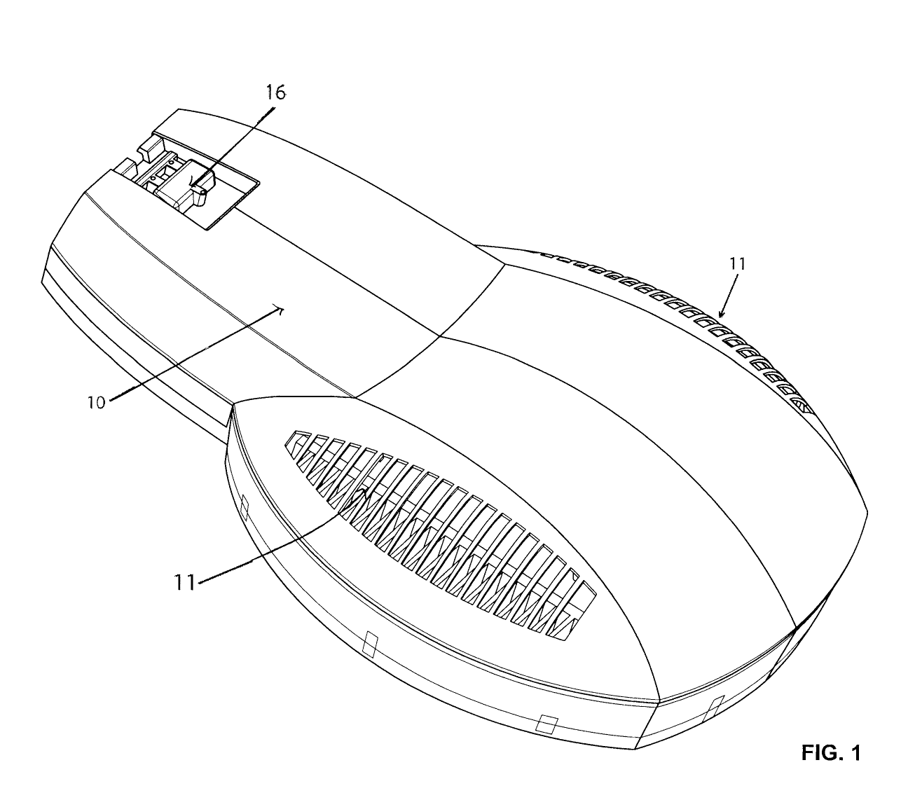

FIG. 1 shows a perspective view from the top of the public lighting device with high energetic efficiency, according to the invention;

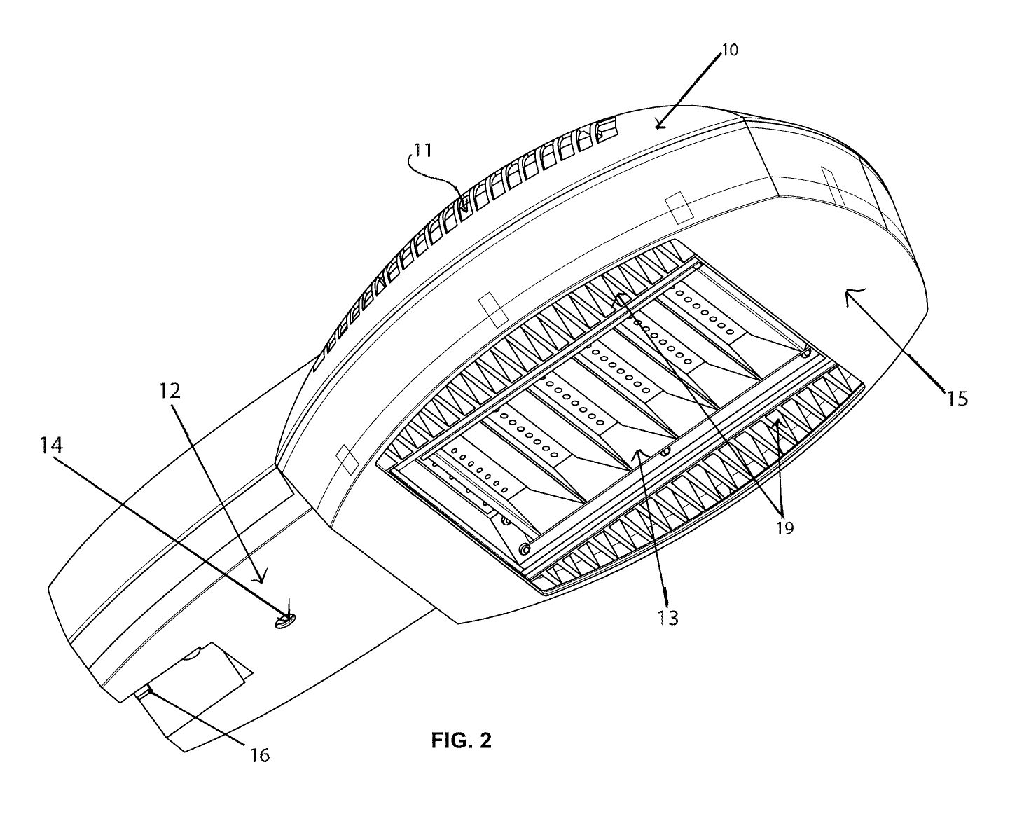

FIG. 2 shows a perspective view from the bottom of the public lighting device with high energetic efficiency, according to the invention;

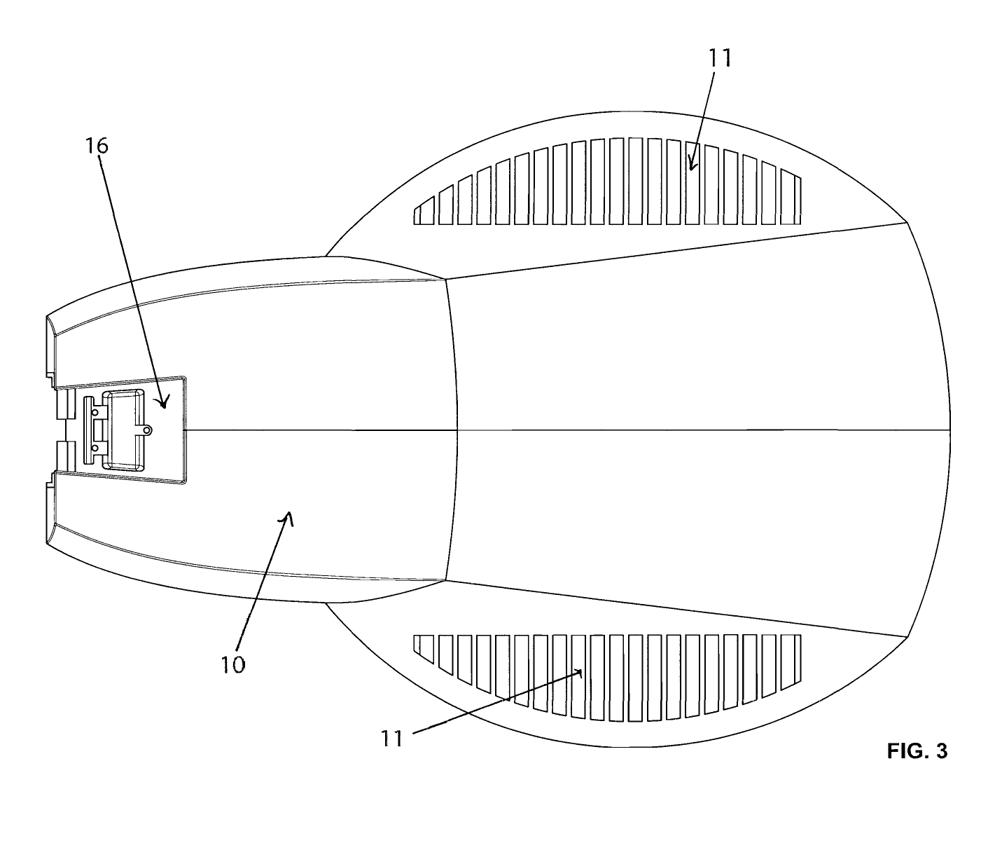

FIG. 3 shows a plan view from the top of the public lighting device with high energetic efficiency, according to the invention;

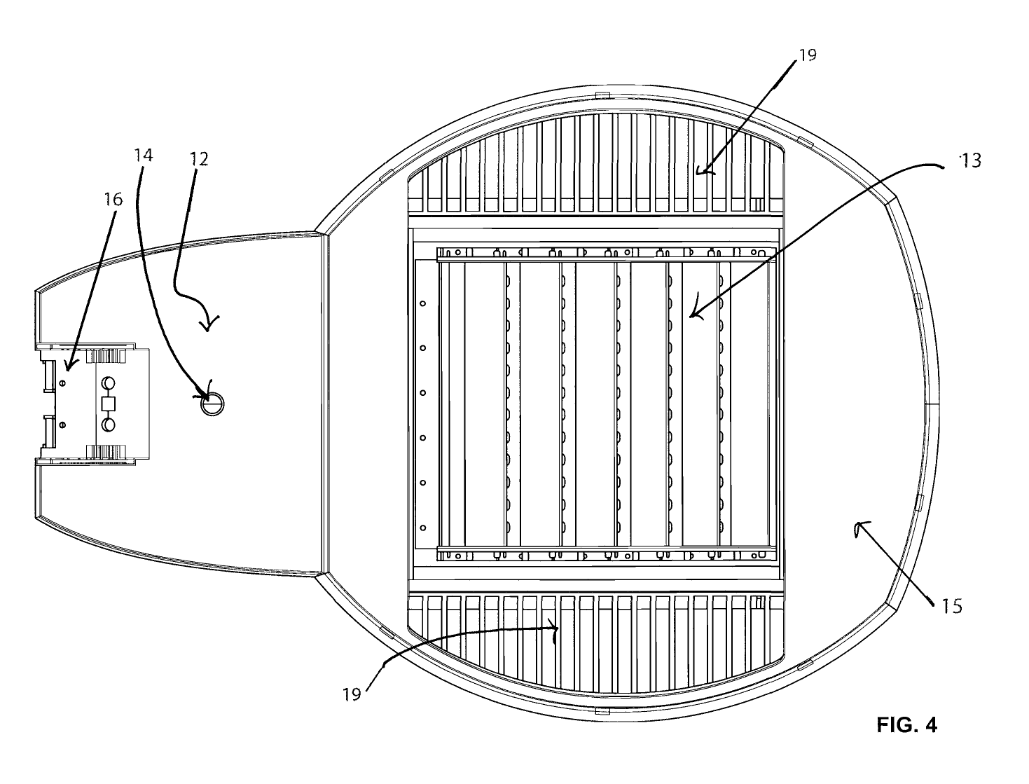

FIG. 4 shows a plan view from the bottom of the public lighting device with high energetic efficiency, according to the invention;

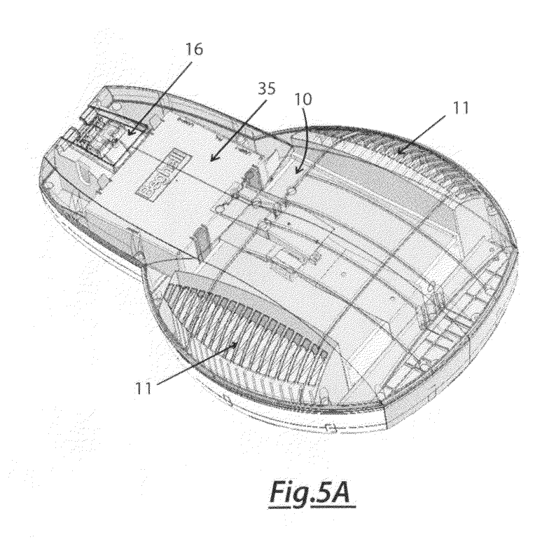

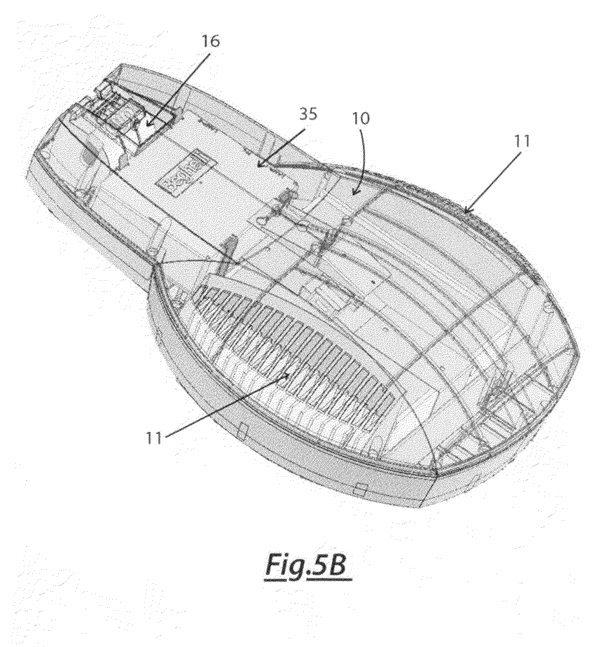

FIGS. 5A and 5B are two perspective views from the top, with the lid in transparency, of the public lighting device with high energetic efficiency, according to the invention;

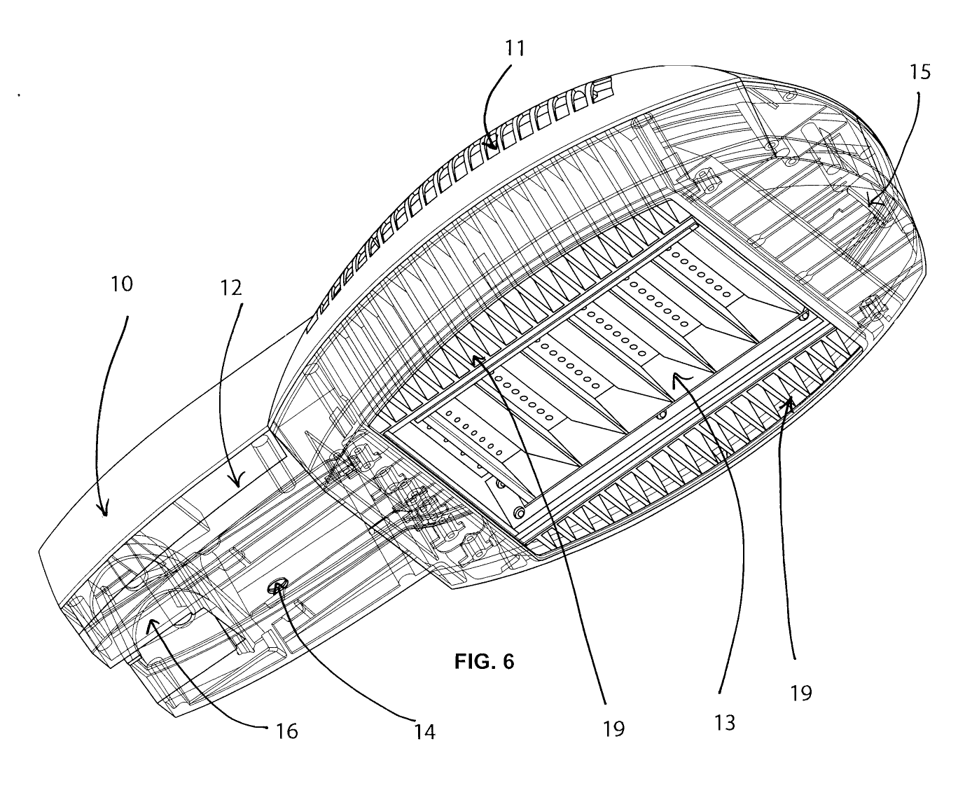

FIG. 6 is a perspective view from the bottom, with the casing base in transparency, of the public lighting device with high energetic efficiency, according to the invention;

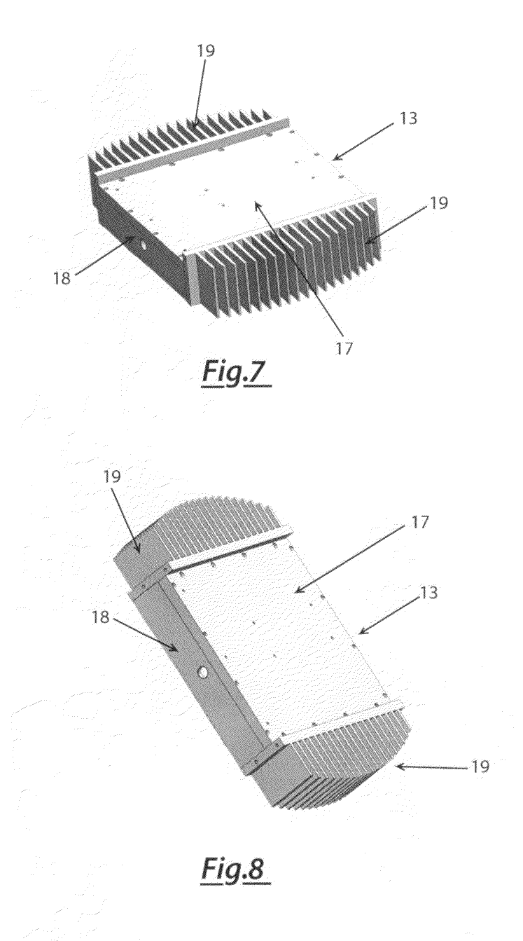

FIGS. 7 and 8 are two perspective views from the top of the LED emitter built-in the public lighting device with high energetic efficiency, according to the invention;

FIG. 9 is a perspective view from the bottom of the LED emitter of FIGS. 7 and 8, according to the present invention;

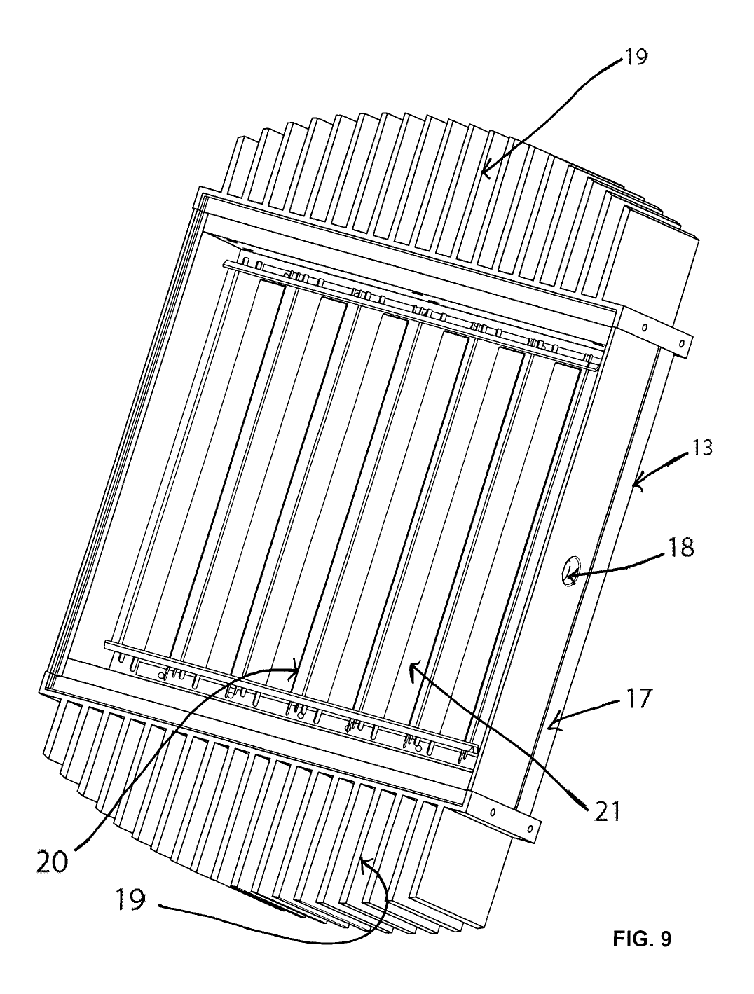

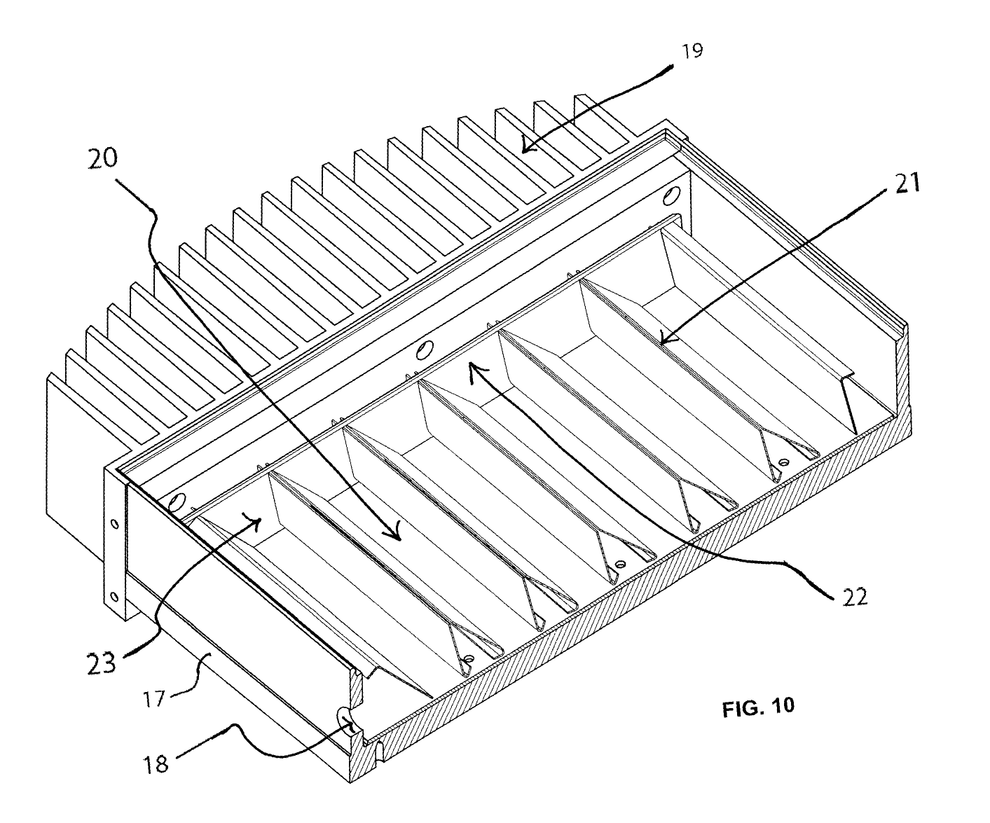

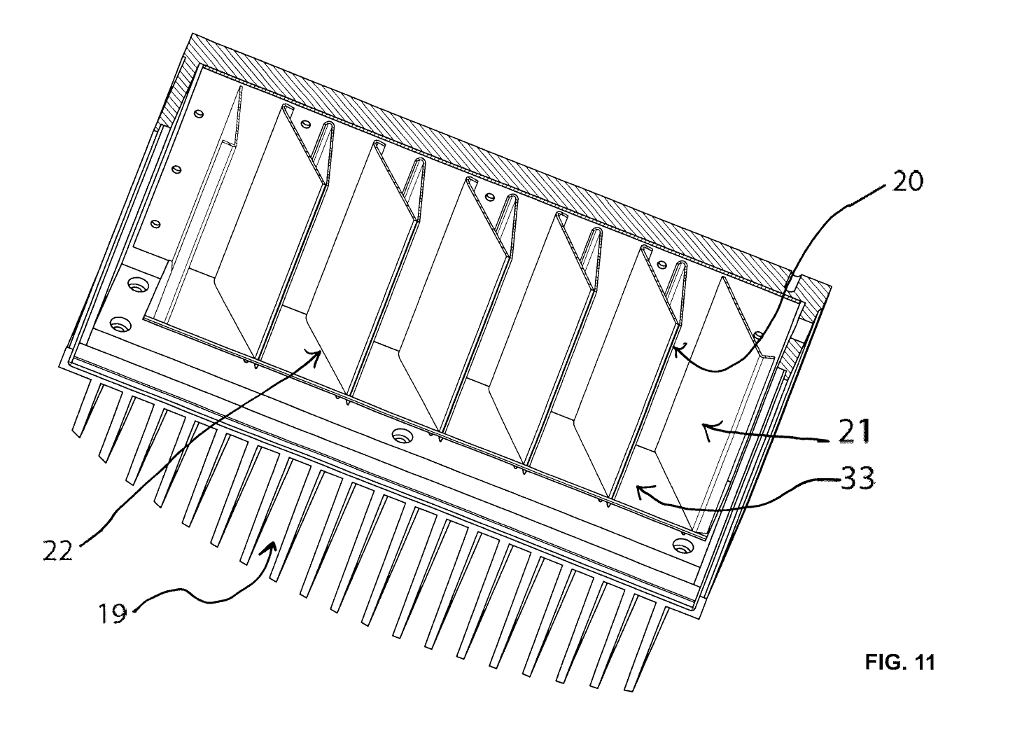

FIGS. 10 and 11 show partially cross sectioned views of the LED emitter of FIGS. 7 and 8, according to the present invention;

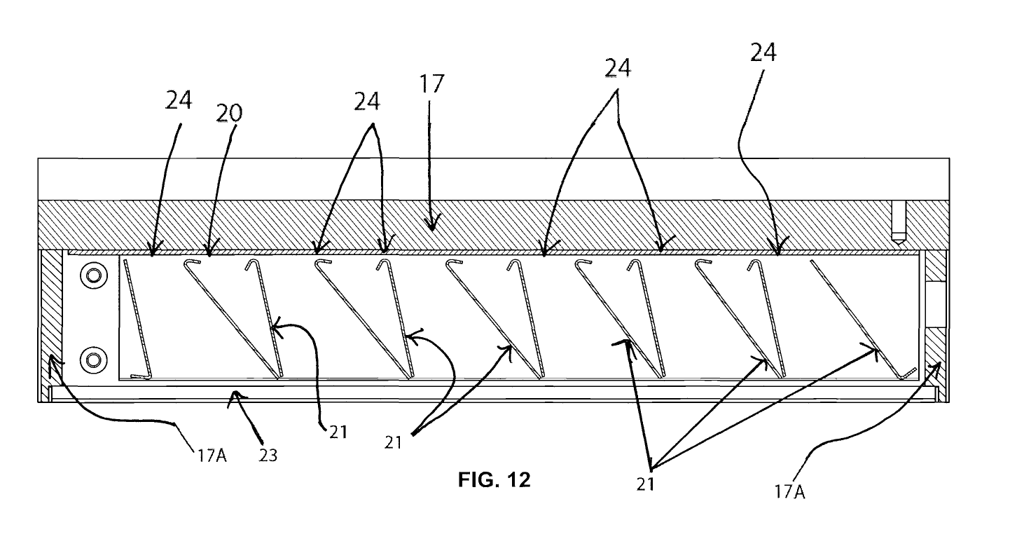

FIG. 12 is a full cross section of the LED emitter of FIGS. 7 and 8, according to the present invention;

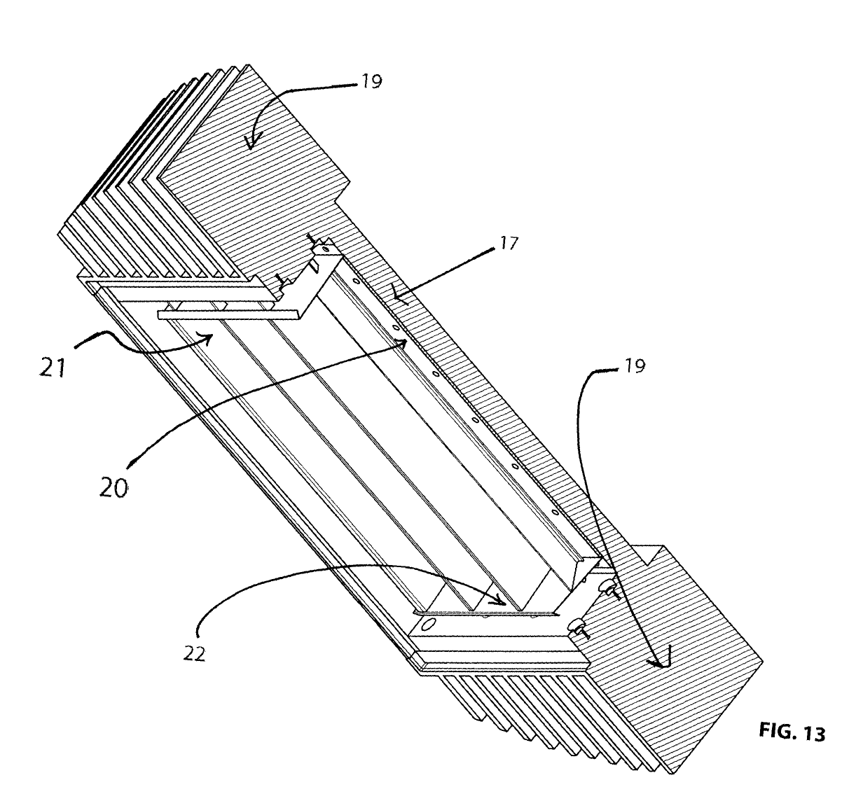

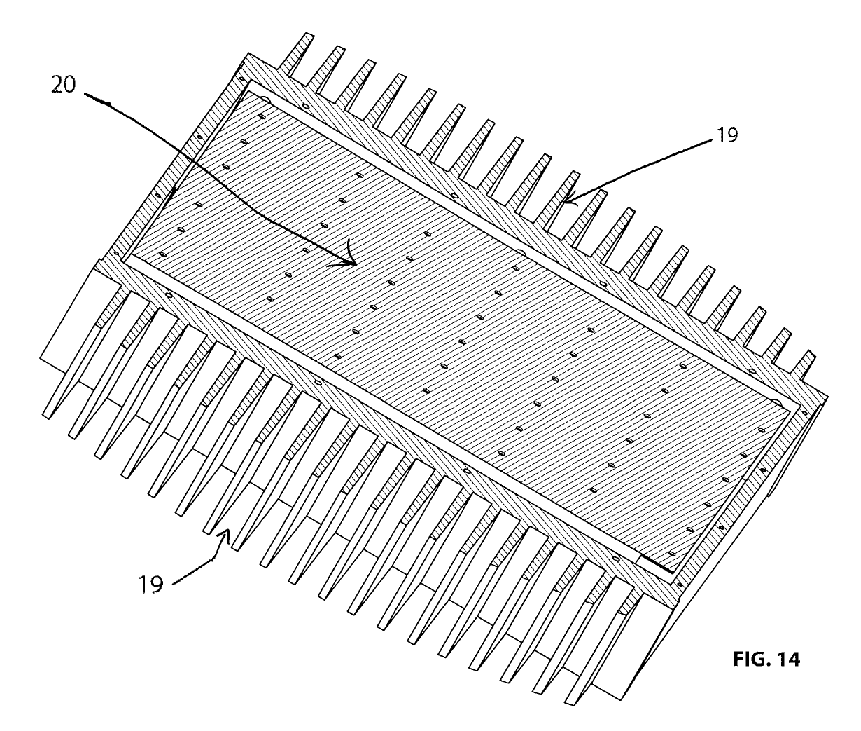

FIGS. 13 and 14 show partially longitudinal sectioned views of the LED emitter LED of FIGS. 7 and 8, according to the present invention;

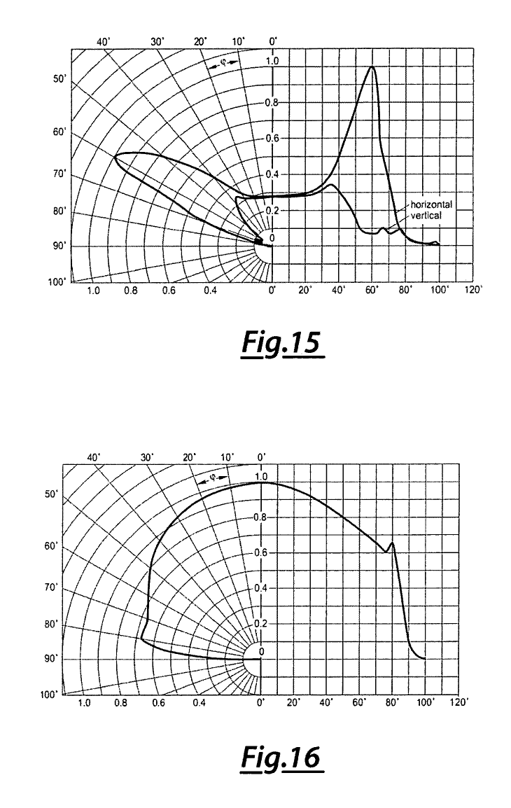

FIG. 15 is a diagram on the light intensity emitted by a first type of LEDs present in the emitter of FIGS. 7 and 8, according to the present invention;

FIG. 16 is a diagram on the light intensity emitted by a second type of LEDs present in the emitter of FIGS. 7 and 8, according to the present invention;

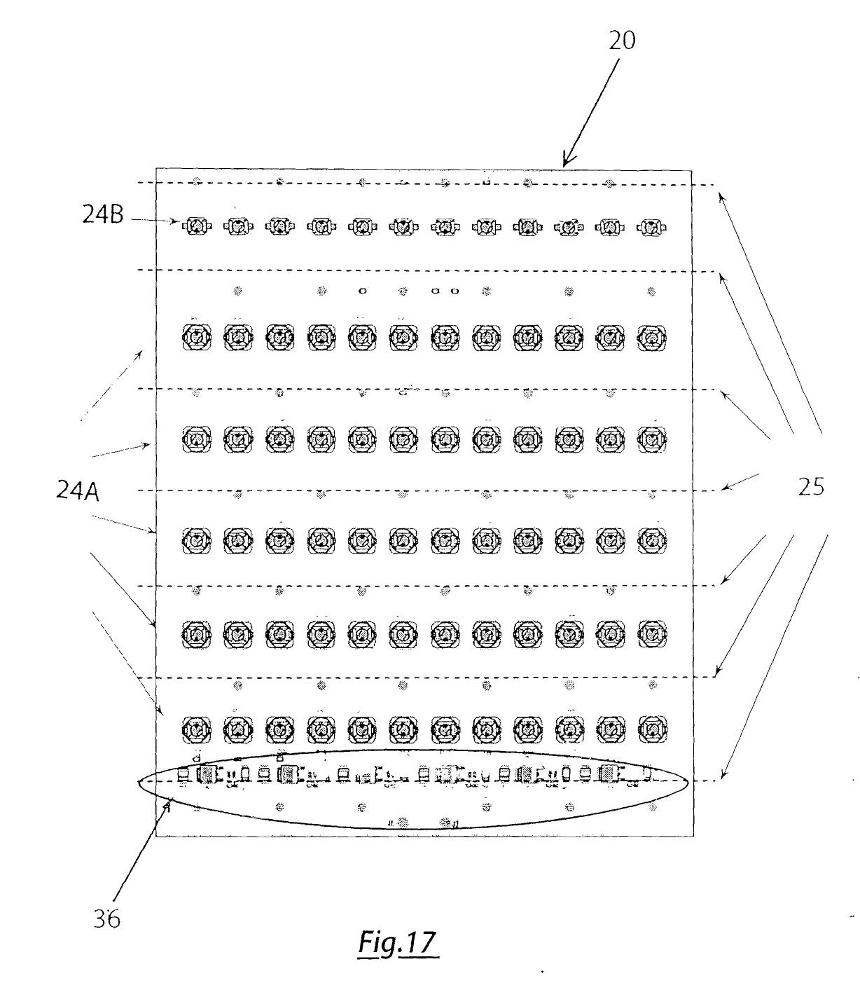

FIG. 17 is a schematic view of the positioning of the power LEDs in the emitter of FIGS. 7 and 8, according to the present invention;

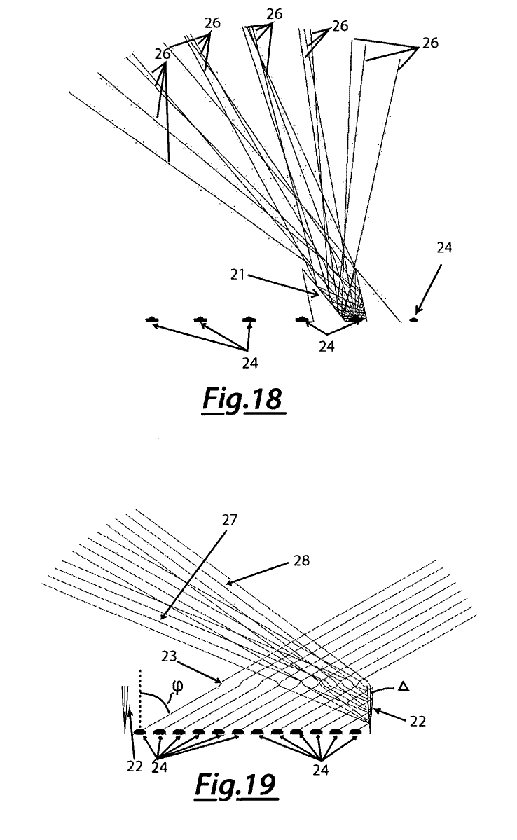

FIG. 18 shows schematically a series of light rays emitted by the LED and reflected on longitudinal mirrors of the emitter of FIGS. 7 and 8, according to the present invention;

FIG. 19 shows schematically a series of light rays emitted by the LED and reflected by transverse mirrors of the emitter of FIGS. 7 and 8, according to the present invention;

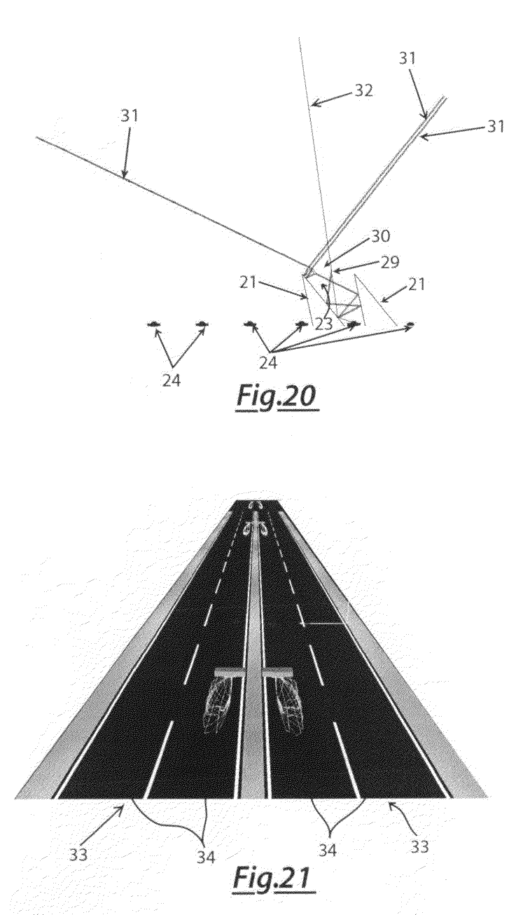

FIG. 20 shows schematically a series of reflected and recovered light rays thanks to the multiple reflections on the mirrors of the emitter of FIGS. 7 and 8, according to the invention;

FIG. 21 shows an embodiment of arrangement of a series of public lighting devices with high energetic efficiency, according to the invention, on a road with dual carriageway;

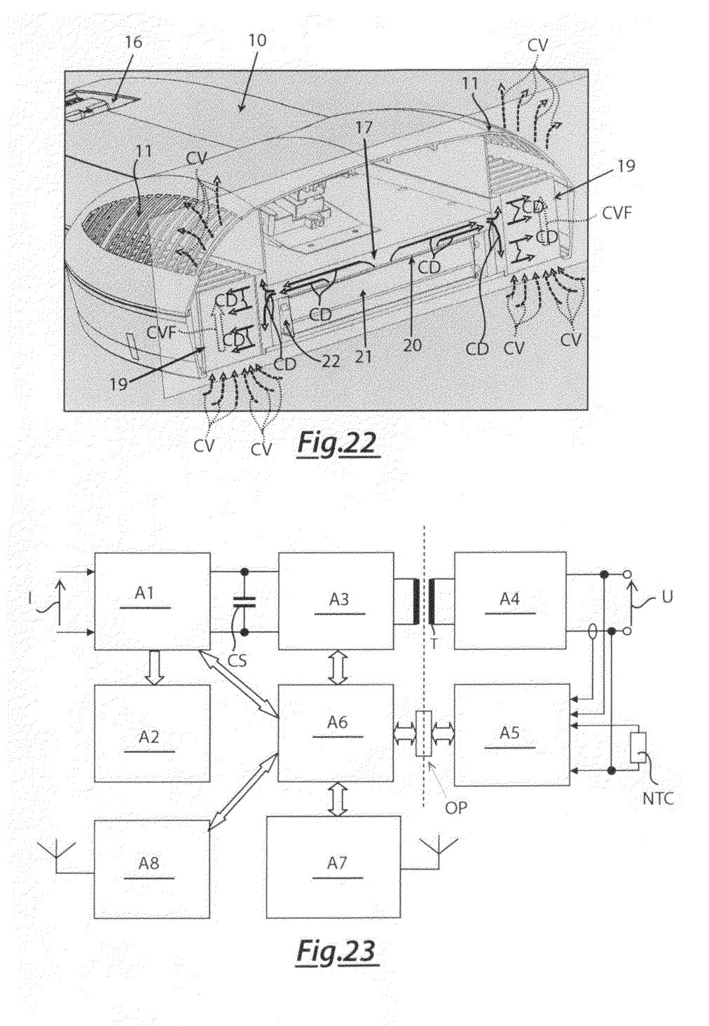

FIG. 22 shows a partially cross sectioned view of the public lighting device with high energetic efficiency, according to the present invention;

FIG. 23 is a block diagram of the electronic feeder used for the operation of the public lighting device with high energetic efficiency, according to the present invention;

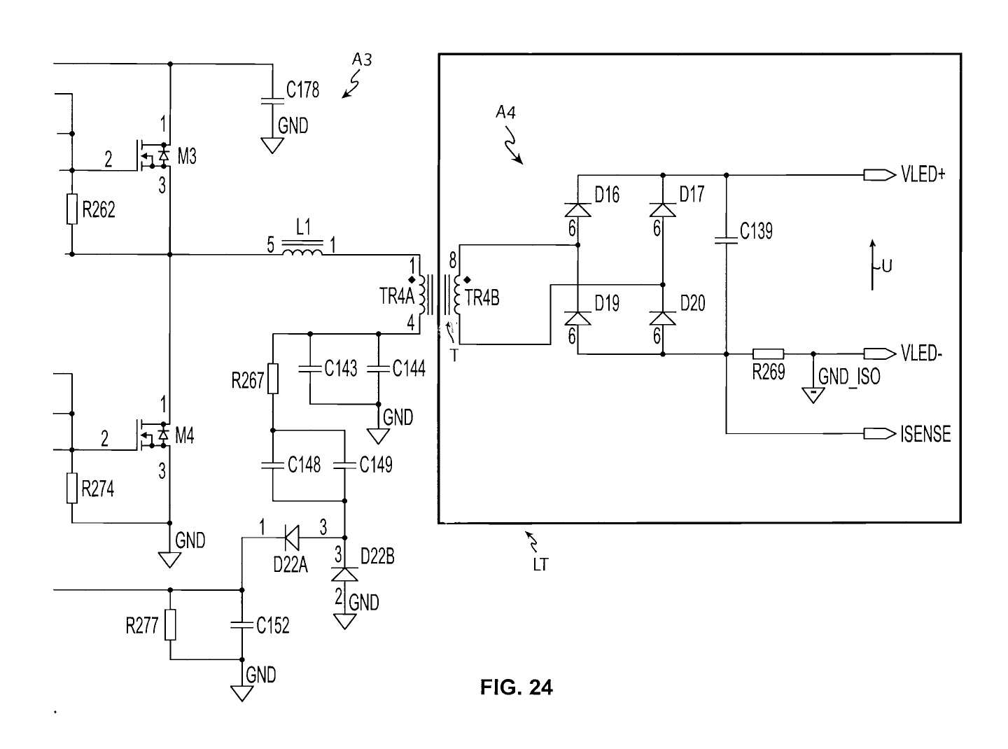

FIG. 24 shows a circuit detail of the architecture of the power stage of the resonant converter used in the feeder of FIG. 23, according to the invention;

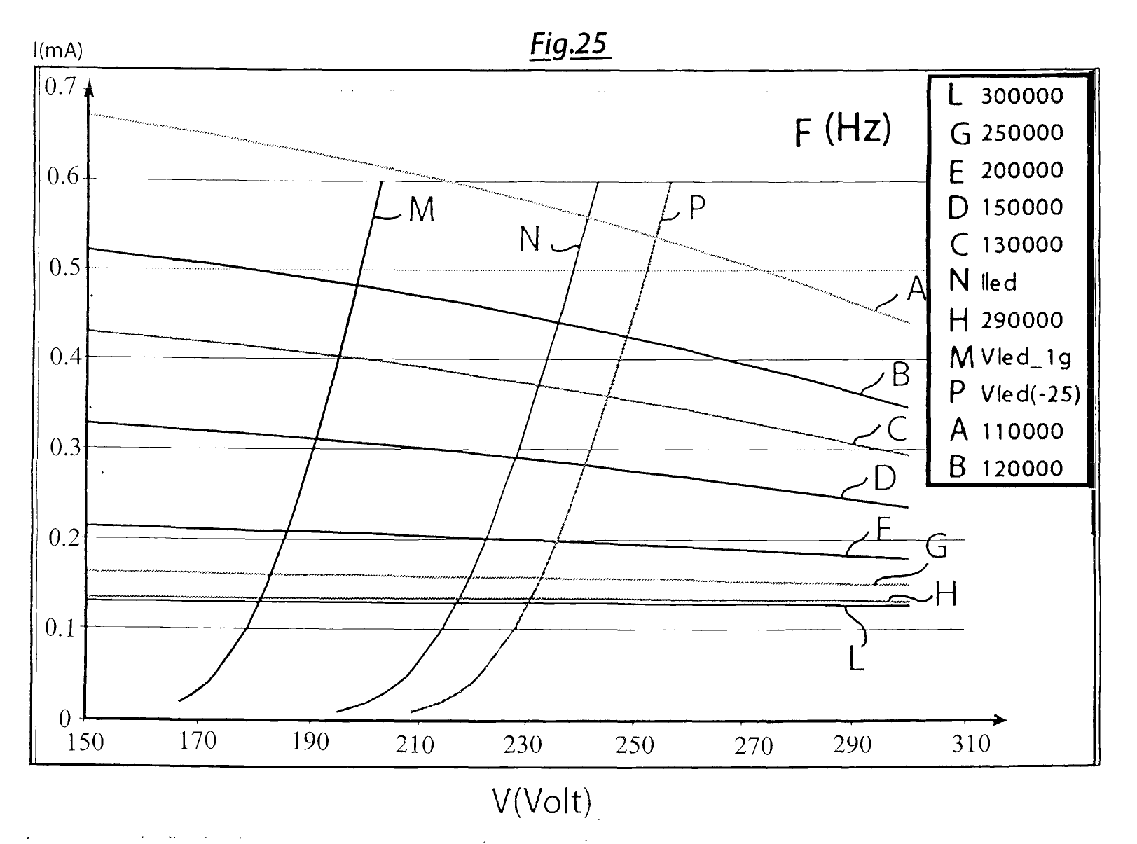

FIG. 25 shows a Cartesian diagram on a series of output I/V features, calculated at different working frequencies, of the resonant converter of FIGS. 23 and 24, according to the present invention;

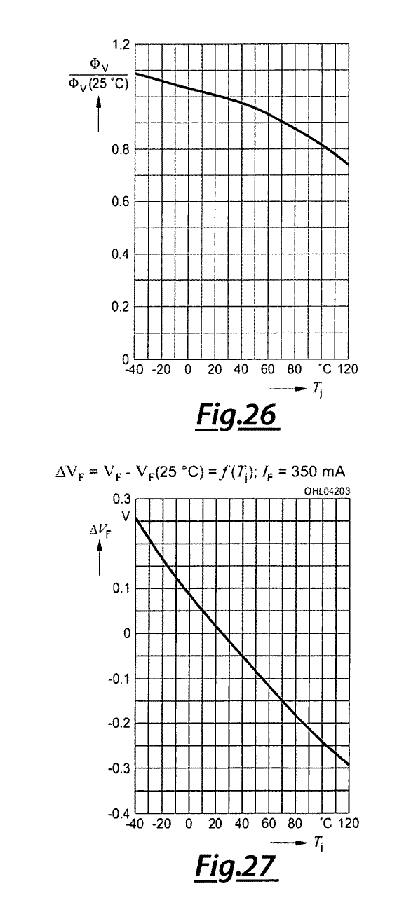

FIG. 26 is a Cartesian diagram showing the relationship between the LEDs junction temperature and the light flux emitted by the public lighting device with high energetic efficiency, according to the present invention;

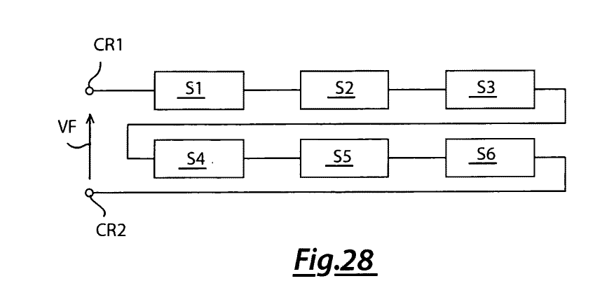

FIG. 27 is a Cartesian diagram showing the relationship between the LEDs junction temperature and the voltage across each string of LEDs, according to the present invention;

FIG. 28 shows a diagram of electrical connection among the string of LEDs of the emitter of the public lighting device with high energetic efficiency, according to the invention, for a lighting device of 72 LEDs;

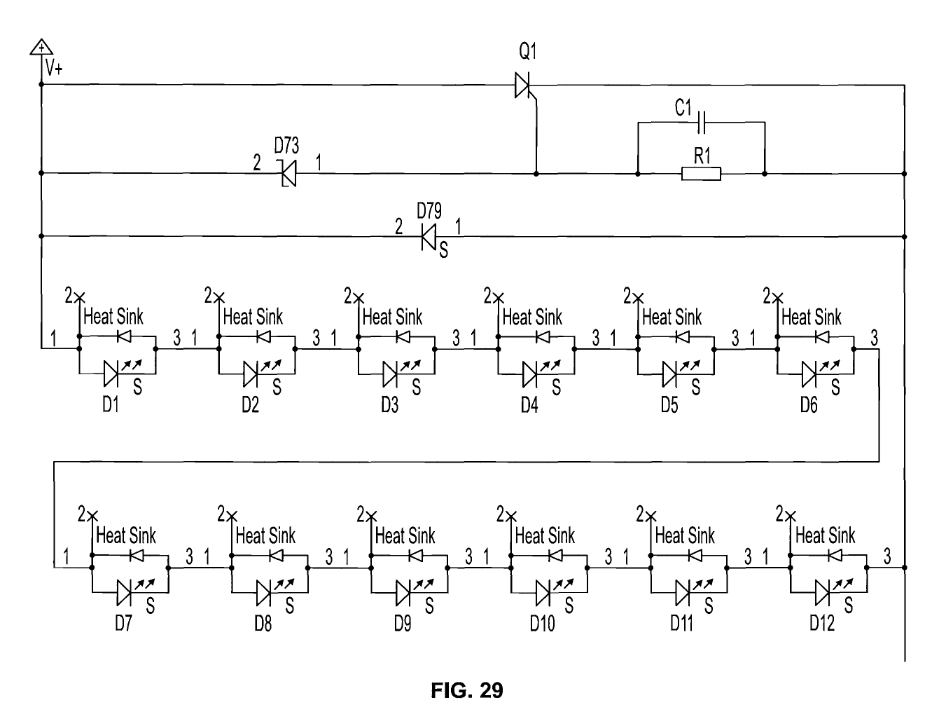

FIG. 29 shows a diagram of electrical connection of each string of 12 LEDs of the emitter of the public lighting device with high energetic efficiency of 72 LEDs of FIG. 28.

With reference to the mentioned and attached figures and, in particular, with reference to the appended FIGS. 1-14, the public lighting device with high energetic efficiency, which is the object of the present invention, includes an upper cover or casing 10, presenting slits 11 for natural ventilation of the device and provided with a connector 16 for electrical and/or mechanical connection with a pole or other supporting element of the device, and a lower base 12 of the casing 10, in which an emitter 13 of lighting LED power, a hole or opening 14 for housing the radio antenna and an area 15 suitable to the insertion of any antenna of Doppler's effect radar controlling the road traffic are made.

The light power emitter 13 includes a base plate 17, preferably made of aluminium for heat dissipation, side walls 17A, also preferably made of aluminium, a side hole or opening 18 for the passage of the electrical cables, a series of finned side heat dissipators 19 and, arranged above the base plate 17, an aluminium printed circuit board 20, with copper insulated tracks (IMS or “Insulated Metal Substrate”), onto which the emitting power LEDs 24, a series of longitudinal mirrors or reflectors 21, made of silvered aluminium or mirror aluminate, and a series of transverse mirrors or reflectors 22 are mounted.

The power transmitter 13 is closed and sealed from the atmospheric agents at the bottom side with an anti-reflective glass 23.

As described above, the operation of the public lighting device, according to the invention, is based on the use of a combination of high power LEDs 24, suitable to the emission of light radiation, and longitudinal mirrors 21 and transverse mirrors 22 properly shaped and placed inside the emitter 13.

The power LEDs 24 are advantageously used in two types, both with built-in primary lens, one so-called of A type and one so-called of B type, which present respective diagrams of light radiation as shown in the FIGS. 15 and 16 attached.

The so-called A type LEDs 24 have a built-in primary lens of asymmetric type and present a peak of light emission for angles of 60° on a plane (referred to as “horizontal” in the diagram of FIG. 15) and a concentration of the light radiation in the field of angles lower than about 50° in the other plane (referred to as “vertical” in the diagram of FIG. 15), orthogonal to the first.

These LEDs of A type, which are used in greater percentage in the lighting device (they are about 80% of the total power LEDs used), have basically the function to light the carriageway directing the light away from the lighting device in longitudinal direction (light emitted with high emission angles in the plane called “horizontal”).

The LEDs 24 of the so-called B type have a symmetrical response with front peak emission and energy contained in a cone of emission of approximately ±80-90°.

These LEDs of B type, used in minor percentage (about 20% of the total), present the function of lighting the areas of the carriageway close to the lighting device, in order to improve the not very high uniformity due to the emission of the LEDs of A type.

Indeed, with the only LEDs of A type would be more difficult to orchestrate the perfect compromise needed for the smooth distribution of the light such that to meet all the requirements for the street lighting. Moreover, as shown in the attached FIGS. 9-14, the public lighting device according to the invention uses two types of reflectors, i.e. a series of longitudinal mirrors 21, which are parallel to the carriageway, and a series of transverse mirrors 22, which are oriented orthogonally to the carriageway.

The attached FIG. 17 shows the layout of the printed circuit board 20, made of aluminium IMS (“Insulated Metal Substrate”), the emitter 13, onto which the power LEDs 24 of A type A and B type (indicated, respectively, with 24A and 24B in FIG. 17, where, through the dotted lines 25, the positions of the longitudinal reflectors 21 are also indicated) are mounted, while FIG. 18 highlights the light rays 26 coming out from the emitter 13, confined among the longitudinal mirrors or reflectors 21, whose purpose is to shape (“cut-off” function) the light emitted by the lighting device in order to direct it on a cross area of desired width of the carriageway and, in particular, in the areas of the road surface which it is intended to light, avoiding dispersing the light elsewhere (in the surrounding countryside or on the roadside).

In addition, the inclination angles of the longitudinal mirrors 21 placed centrally to the structure of the emitter 13 are also optimized in order to get a good cross uniformity on the carriageway.

Similarly, the attached FIG. 19 shows the light rays coming out from the emitter 13 and confined thanks to the side and/or transverse mirrors or reflectors 22, whose purpose is to direct the light far away on the carriageway, increasing the longitudinal emission angle φ.

In particular, in this way it is possible to direct a part of the light emitted far away from the lighting device (reflected rays 27 with (φ+Δ) increased angle), increasing the possible distance between centre of installation of the devices themselves and the effect is to increase the emission angle φ beyond 60° for the power LEDs 24 of A type.

As illustrated in detail in FIG. 19, the use of the transverse reflectors 22 can also move, in some models of lighting devices, part of the light on minor emission angles (reflected rays 28 with (φ−Δ) decreased angle), correcting the emission of the power LEDs 24 in order to make more uniform the lighting of the carriageway in areas closer to the lighting device.

The advantages of the longitudinal mirrors 21 and transverse mirrors 22 are thus evident, since the same allow to direct at will the light rays coming out from the emitter 13 and, in particular, the longitudinal mirrors 21 allow to use the light which would be dispersed laterally to the carriageway in order to re-enter it in the aforesaid carriageway, while the transverse mirrors 22 allow to correct the emission of the lighting device in longitudinal direction to the carriageway, increasing the emission angles, both in case it is desired to increase the mutual positioning distance between centre of the lighting devices, and in case it is necessary to better distribute the light improving the longitudinal uniformity.

The longitudinal 21 and transverse 22 mirrors or reflectors allow then, in general, to configure the diagram of emission of the single lighting device so as to meet the lighting requirements required for the street lighting without changing the primary lens of the power LEDs 24 used.

In this way, it is possible to design public lighting device with the best lighting features, always using the same standard models of power LEDs 24.

Another advantage of the use of the longitudinal 21 and transverse 22 mirrors or reflectors is the partial recovery of losses for “Fresnel's effect” when crossing the glass 23 of those mirrors or reflectors 21 and/or 22, since such a glass 23, although provided with so-called “anti-glare” treatment, is inevitably characterized by losses by reflection, especially for very grazing incidence of the light rays.

As shown qualitatively in the appended FIG. 20, due to the chosen angles and use of high reflectance mirrors 21, 22, the rays which, as a result of the reflections on the glass 23 (in the attached FIG. 20 a first reflection 29 and a second reflection 30 on the glass 23 are shown), return inside the emitter 13 envelope, are again propagated into the useful half space.

Thanks to the use of very high reflectance mirrors (>95%, in case of use of silvered aluminium), the multiple reflections do not cause excessive attenuation of the energy of the light rays and this significantly allow to increase the efficiency of the system.

In summary, thanks to the fact that the LED emitters 24 are surrounded by high reflectance mirrors 21, 22, the light is “iteratively” re-emitted and re-directed to areas useful for the street lighting.

This happens for almost all the angles of incidence (in particular, in the appended FIG. 20, by way of example, a beam 32 directly reflected by the mirror 21 and a set of rays 32 reflected by the glass 23, which are recovered thanks to the multiple reflections on the mirrors 21, are shown).

Other advantageous features of the public lighting device according to the invention are given by the flat layout, which optimizes the installation and reduces production costs, by the developed design, which is of scalable type and allows, therefore, while the LEDs technology constantly evolves, to update the project without great investments, and by the angular arrangement of the reflectors or mirrors 21, 22, which allows to get a compact and bulky structure, in order to save space.

In the following discussion, by way of preferred but not limiting example, the application of 72 power LEDs lighting devices, according to the present invention, is described, suitable to the lighting of a carriageway 33 with two lanes 34 mounted centrally between the two adjacent lanes 33 (as shown in detail in the enclosed FIG. 21).

The lighting parameters calculated for two parallel carriageways 33.5 m long and 8 m wide, each with two lanes and road surface C2, q0=0.070 and maintenance factor=0.80, height of installation of the lighting device of 9 m. from the ground, distance among the support poles of the respective lighting devices of 33.5 m. and chosen class lighting ME3a are as follows:

| | Luminance Lₘ | Uniformity | Uniformity | Dazzling | |
|---|---|---|---|---|---|
| | (cd/m²) | U0 | U1 | T1 (%) | SR |
| Reckoned | 1.1 | 0.4 | 0.7 | 10 | 0.7 |
| actual | | | | | |
| values | | | | | |
| Nominal | ≧1.0 | ≧0.4 | ≧0.7 | ≦15 | ≧0.5 |
| values | | | | | |
| according | | | | | |
| to class | | | | | |

As it can be noted from the result obtained, all photometric requirements are met and excellent performances in terms of uniformity (U0, U1), luminance (Lm) and dazzling (TI) are highlighted.

The technical solution described is also optimized for the disposal of heat generated by the power LEDs 24, as shown in detail in the attached FIG. 22.

Indeed, the aluminium base plate 17, onto which the power LEDs 24 are mounted, coveys heat, by conduction (according to the directions of the arrows indicated with CD in the FIG. 22 enclosed), towards the side finned heat dissipators 19, which yields, by natural convection (according to the directions of the arrows indicated with CV in the appended FIG. 22), the heat generated to the air flux CVF of the external environment, crossing them vertically.

The performances are thus excellent, since the junction temperature of the power LEDs 24 remains below 55-60° C. at a room temperature of 25° C.

This low operating temperature allows a high reliability extending the useful life of the product and at the same time allows to get excellent lighting performances (as described in detail further on, the light flux emitted by the LEDs 24 decreases with the increasing of the junction temperature).

The solution also enables excellent convey of heat outside while avoiding exposing the heat dissipators 19 outside of the lighting device, with a significant improvement in aesthetics, compared to traditional solutions.

The side slits 11 of casing 10 are however thin enough to guarantee a good protection against dirt and penetration of foreign objects.

The operation of the lighting device according to the invention is assigned to an electronic feeder, mounted inside a proper resinated container 35 and its architecture is explained in detail in the block diagram of the attached FIG. 23.

The electronic feeder is housed in the rear part of the lighting device and includes an electronic circuit 20 built-in in a plastic case completely sealed with high degree of electrical insulation silicone resin for a complete protection from the atmospheric agents.

The power supply is of the high efficiency type, with galvanic insulation between input I (to which the network voltage of 230 Volts at alternating current (AC) is applied) and output U (at which there the nominal supply voltage of the power LEDs 24 string is provided), and is practically constituted of the cascade of two power converters, respectively indicated with A1 and A3-A4 in the attached FIG. 23.

The converter A1 is a converter of the “AC/DC boost” type for the function PFC (“Power Factor Correction”) and consists of a classical stage with one MOSFET, one diode, one inductor, one storage capacitor CS and one low-cost and widely spread integrated controller, for example of “transition mode” and widely type (such as the integrated ST L6562).

The converter A3-A4 is a converter of the DC/DC resonant type, able to drive at high frequency (tens of kHz), through an LC resonant network, the insulation transformer T.

Downstream the insulation transformer T, the output stage A4 of the A3-A4 resonant converter is provided, consisting of a rectifier and filtering block, able to power at the output U a string of power LEDs 24, which, in the described favourite, but not limited to, example of the present invention, consists of 72 LEDs connected in series, at a nominal voltage of 72*3.2 Volts=230 Volts and at a nominal direct current (DC) of 350 mA.

The converter stage A1 is characterized by a yield η₁ higher than 96%, while the assembly of the converter stage A3 and rectifier and filtering stage A4 is characterized by an overall yield η₂ higher than 97%. In this way, the resulting overall conversion yield is equal to the value η_{c}=η₁*η₂, which is higher than 93%, very high value for an isolated low power converter.

This architecture allows, by means of the resonant converter A3-A4 at the output, to achieve a high efficiency feeder having at the same time the advantage of a galvanic insulation between input I and output U and at the same time meeting the requirements on the harmonic currents absorbed by electric system, thanks to the stage PFC of the input converter A1.

The microcontroller A6 manages the operation of the electronic feeder by controlling moment by moment all the operating parameters thereof and, in particular, it:
measures current, voltage and active power absorbed by the electric system at 230 Volts AC;
measures power LEDs 24 voltage, current and temperature by communicating across the insulation barrier with the output microcontroller A5;
controls the resonant converter A3;
adjusts in feedback the power supplied to LEDs according to predefined algorithms;
allows the transmission and receiving of radio diagnostics, control and monitoring signals through the radio transceiver of “spread spectrum” A7 type.

The microcontroller A5 manages the measure of the output parameters of the converter (current and voltage on the power LEDs and temperature of the LEDs themselves) and transmits them, through the opto-insulators OP and a serial communication interface, to the main microcontroller A6.

The communication interface is standard and does not require great speed features because the converter A3 is designed to operate in open loop without damaging itself and the load (the power LEDs 24), even when the feedback control is not active.

It has to be reminded that the power LEDs 24 constitute a load characterized by slow dynamics (in the order of seconds, since this is the thermal dynamics due to the variations in the electrical parameters caused by the variations in temperature caused by the heating and cooling of the LEDs themselves), then the bandwidth of the measure microcontroller A5 can be sufficiently slow (allowable measures delay in the order of tens/hundreds of ms).

This architecture of the electronic feeder also allows to greatly simplify the insulated circuits of measure of the output parameters and build a digital feedback control (consisting of the assembly of the two microcontrollers A5, A6) with very low cost components, without needing DSP.

The radio transceiver “spread spectrum” A7, for example of the FH-DSSS (“Frequency Hopping”—“Direct Sequence Spread Spectrum”) type, operating in the band 2.400-2.483 GHz, is able to exchanging signals and/or data at a few hundreds of Kbit/s with apparatuses and devices external to the lighting device, while the feeder A2 is a service, low power and high efficiency, feeder, for example of “flyback” type, which provides the auxiliary power supplies to all the active parts of the lighting device.

Finally, the electronic feeder described may possibly include a Doppler's effect radar (optional) A8, managed by the microcontroller A6 and suitable to verify the presence of cars or pedestrians on the carriageway and to measure their movement.

The attached FIG. 24 shows in detail the architecture of the power stage of the resonant converter A3 and output rectifier stage A4, where it is possible to see that the control of the convert A3 is performed by the microcontroller A6 by adjusting the switching frequency of the H-shaped half-bridge formed by the transistors M3, M4, which always switch at phase opposite each other taking the power from the 400-500 Volts bus BS connected with the drain DR of M3.

The adjustment of output power, from the insulated side LT, occurs by changing the frequency, following to which the variation in the phase difference between voltage and current in the resonant circuit consisting of L1, C143 and C144 results and, consequently, the variation in the active output power; in addition, the circuit is designed so that the switching of the transistors M3 and M4 always occurs at null voltage (“Zero Voltage Switching”) thus allowing a very high efficiency of the converter A3.

The attached FIG. 25 shows, by way of example, the curves of trend of the drive current of the power LEDs (in mA) as a function of the operating voltage of these LEDs (in Volts), at the output of the resonant converter A3, calculated at different working frequencies F (110,000 to 300,000 Hz, curves indicated respectively with the references A, B, C, D, E, G, H, L), crossed with the curves of load of the power LEDs (exponential increasing stretches of voltage and current indicated, respectively, with M, N, P).

As it is possible to see from the chart, for a given configuration of power LEDs, it is possible, for example, to change the working point of the LEDs from 550 mA to 150 mA and over.

The microcontroller A6 is then able to adjust the current of the LEDs and, therefore, output power by controlling the frequency of the converter A3; the microcontroller A is also able to adjust the average intensity of the electrical output variables (power of the LEDs) by controlling the duty-cycle of turning on of the converter A3, which, indeed, is characterized by an on and off transition of few hundreds of μs and, as a consequence, it is possible to create on and off (ON-OFF) cycles of the converter A3 with characteristic frequency higher than 100-200 Hz, in order to avoid the effects of light “flicker” typical of low frequencies switching.

In this way, by operating the converter A3 at periodic “burst”, it is possible to adjust the brightness of the LEDs 24 up to the very low average levels, around 1% of the nominal value.

The chart illustrated in the attached FIG. 26 shows the characteristic trend of the variation in the light flux Φv of the power LEDs 24 as the junction temperature Tj varies; it can be noted that the flux Φv decreases with the increase of the temperature Tj and vice versa.

Once set the nominal operating point at the nominal room temperature of 25° C., the junctions of the LEDs 24 work at the working temperature determined by the lighting device, such as 55° C.

If the room temperature increases of 15° C., for example in summer conditions, also the junction temperature Tj increases of 15° C., reaching for example 55° C.+15° C.=70° C. and, therefore, Φv the light flux decreases of approximately 5-10%.

Vice versa, for example in winter conditions, when the room temperature falls down and, then, as a result, the junction temperature Tj falls down, the light flux Φv can increase up to a +5/+10%.

The electronic feeder of the lighting device, which is the object of the present invention, since is also able to measure the temperature of the LEDs, can compensate accordingly the drive power of the device in order to keep constant the light flux Φv, namely by increasing the power during summer and lowering it during winter. In specifically designed embodiments for energy saving, the summer increase can be under-compensated (eroding a bit of margin to the maintenance factor of the lighting device) in order to give priority to the reduction of winter power; from estimates made, this strategy leads to a lower consumption of electricity of the lighting device higher than 5% per year.

The temperature of the LEDs can be measured in two ways:
directly, through the sensor NTC connected with the microcontroller A5 and mounted on the aluminium printed circuit board 20 of the LEDs 24, which directly measures the temperature of the base plate 17 and, consequently, the junction temperature Tj of the LED 24 (since the thermal junction-plate resistance is known, as well as the drive power);
indirectly, by measuring the direct voltage of the string of LEDs (this second method allows to save the use of the temperature sensor NTC).

The aforesaid indirect measurement of the temperature of the LEDs is basically on the dependence of the junction temperature Tⱼ of the LEDs and the voltage ΔV_{F} taken across the LEDs string (reported in the chart shown in the appended FIG. 27), where ΔV_{F}(Tⱼ)=V_{F}(T₃)−V_{F} (25° C.)=f (Tⱼ) and I_{F}=350 mA. As said, the electronic feeder measures with sufficient precision the voltage of string of the LEDs, while, during phase of test of end line of the lighting device or street lamp, the test system measures the room temperature near the table where the lighting device is positioned for the final test, after the device has been previously switched off for a time sufficient to fully cool down the base plate 17 of the power LEDs 24 and the LEDs 24 themselves (therefore, the LEDs 24 and their junctions are at room temperature).

At this point, the test equipment sends to the lighting device or street lamp under test a special radio signal which instructs the microcontroller A6 to turn on the LEDs 24 with a very short pulse at which the microcontroller A5 instantly measures the voltage VF of the still cold LEDs 24.

In this way, the electronic feeder of the lighting device captures and stores the voltage value VF of the LEDs 24 at a known reference temperature (which is that one of the test room, in the meantime communicated to it via radio from the test system).

From this point on, the feeder is able to reconstruct the temperature of the LEDs by simply measuring the operating voltage VF and comparing it with that one recorded during test phase.

In illustrative and preferred, but not limited to, embodiments of the invention, the power LEDs 24 are all connected in series.

FIG. 28 attached, for example, shows an electrical connection of six strings S1, S2, S3, S4, S5, S6 of 12 LEDs each, which can be used for a lighting device of 72 LEDs, while FIG. 29 attached shows a typical electrical connection which can be used between the input X and output Y of each single string (S1 or S2 or S3 or S4 or S5 or S6) formed by 12 LEDs.

The solutions of electrical connection schematized in the appended FIGS. 28 and 29 fully simplify the wiring between the electronic feeder and base plate 17 onto which the LEDs 24 are positioned.

Indeed, the LEDs 24 are connected with the base plate 17 according to the electrical schemes of the FIGS. 28 and 29 and the connection between the base plate 17 and feeder requires only two copper wires CR1, CR2; therefore, the series connection firstly provides a significant construction advantage.

Furthermore, the electrical connection described does not provide any problem in case of breakage of any LED due to short circuit, since in this case, all the other LEDs of the string will continue to operate properly. Moreover, the electronic feeder is able to diagnose this condition by detecting the overall voltage drop and implementing all the possible strategies and countermeasures in order to balance performances degradation, such as, for example, an increase of current in the LEDs still working in order to balance the light flux lost.

Even in the case of open circuit breakages of the individual LEDs 24, the electrical circuit shown in the attached FIG. 29 is able to manage the problem, since the division into six strings S1, S2, S3, S4, S5, S6 offers the important functional advantage of making the six groups of 12 LEDs each independent.

Indeed, with reference to the appended FIG. 29, if an LED of a string S1, S2, S3, S4, S5, S6 breaks turning into open circuit, for example due to aging, the automatic intervention of the circuit comprising the SCR diode Q1, struck by the Zener diode D73 occurs. Indeed, following the opening of an LED 24 of the string S1, S2, S3, S4, S5, S6, the voltage across the LED immediately increases and, consequently, the voltage across the string increases up to allow conduction of the Zener diode D73, which strikes the SCR diode Q1, which, in turn, short-circuits the entire string S1, S2, S3, S4, S5, S6.

This mechanism therefore allows the circulation of current in the string S1, S2, S3, S4, S5, S6 with any LED 24 open within the string itself, in order to not compromise the entire operation of the lighting device and providing continuous operation even in case of breakage.

The components D73, Q1, . . . are mounted on the same printed circuit board 20 of the power LEDs 24, as shown in the appended FIG. 17 at position 36.

The lighting device continues to operate, for example with ⅚ of the total LEDs still active, since only the string of LEDs containing the damaged LED has short-circuited; the device is therefore “fault tolerant” against the breakage of individual LEDs 24.

Furthermore, in case of breakage (for opening) of a single LED 24, the related string S1, S2, S3, S4, S5, S6 automatically short-circuits, allowing the operation of the other strings, while the feeder, by measuring the overall voltage at its own output U, immediately identifies the fault condition and automatically increases the drive current in order to compensate the lower overall flux resulting from the residual operation of only five LEDs present in the string itself, continuing to work with performances identical to the original ones.

Indeed, the feeder is able to increase the current drive in order to exactly compensate the minimum number of LEDs, simply at the expense of a lower overall efficiency, since the residual LEDs will work at a point characterized by less efficiency.

The excellent architecture of dissipation of the produced heat allows, then, the residual LEDs to work still in widely safe operating conditions, with junction temperatures still lower than 70° C.

In addition, the strings S1, S2, S3, S4, S5, S6 of LEDs 24 are positioned on the printed circuit board 20 so that each of them is advantageously placed in direction orthogonal to the longitudinal mirrors 21, since such positioning allows each string to contribute for ⅙ to the overall optical performances of the lighting device; indeed, the lighting diagram does not change and the light flux emitted remains the same thanks to the increase of the drive current, even in case of switching off of an entire string S1-S6.

In case of breakage (for opening) of two LEDs in two strings different S1, S2, S3, S4, S5, S6, the feeder, while diagnosing this condition, continues to feed the remaining strings, by increasing the drive current, but in this case does not fully compensate the smaller residual flux and the lighting device continues to operate at reduced performances; the lighting diagram does not change, but the light flux is slightly reduced (the reduction will be in the order of ⅙, against the lack of functioning of 2/6 of the LEDs).

The same strategy will go through each breakage of subsequent strings, till the extreme case where only one string is working, that can be double current driven, with a resulting luminous flux of approximately 25% of the nominal flux of the lighting device.

Therefore, the great advantage of the described embodiment is clear, which combines the simplicity of construction with good electrical performances in case of breakage.

The technical features of the public lighting device with high energetic efficiency, according to the present invention, as well the advantages, are clear from the description made.

It is, finally, clear that many other variations may be made to the public lighting device in question, without departing from the principle of novelty intrinsic in the inventive idea expressed here, as it is clear that, in the practical implementation of the invention, materials, shapes and sizes of the illustrated details can be changed, as needed, and replaced with others technically equivalent.

1. Public lighting device with high energetic efficiency, including at least one casing (10, 12) for containing at least one light source, suitable to be connected with at least one support element, wherein said casing (10, 12) includes at least one emitting device (13) of LEDs light radiation, characterized in that said emitting device (13) of light radiation comprises at least one base plate (17), made at least partially of conductive material, on which a printed circuit board (20) of control and management of a series of power-emitting LEDs (24), a series of longitudinal mirrors or reflectors (21), which develop on planes parallel each other and substantially orthogonal to the plane towards which said light radiation is directed, and a series of transverse mirrors or reflectors (22), which develop on planes parallel each other and substantially orthogonal to the development planes of said longitudinal mirrors or reflectors (21), are mounted, heat dissipators (19), to which respective slits or cracks (11) made in said containment casing (10, 12) correspond, being connected with said base plate (17) and contained inside said casing (10, 12).

2. Public lighting device as claim 1, characterized in that said LEDs (24) can be grouped into at least two different types, a first type of LEDs (24A), comprising the most part of LEDs (24) provided inside said emitting device (13) of light radiation, incorporates an asymmetrical primary lens and is suitable to direct the light radiation away from the lighting device in a longitudinal direction, while a second type of LEDs (24B) incorporates a symmetric primary lens and is suitable to direct the light radiation in areas close to the lighting device.

3. Public lighting device as claim 1, characterized in that said longitudinal mirrors or reflectors (21) present at least one surface having at least one predetermined inclination angle with respect to a plane orthogonal to said base plate (17) of said emitting device (13).

4. Public lighting device as claim 1, characterized in that said transverse mirrors or reflectors (22) present at least one surface having at least one predetermined inclination angle with respect to a plane parallel to said base plate (17) of the emitting device (13).

5. Public lighting device as claim 1, characterized in that said longitudinal (21) and/or transverse (22) mirrors or reflectors are made of high reflectance material and provided with anti-reflective glass (23).

6. Public lighting device as claim 1, characterized in that said heat dissipators (19) are finned and are placed laterally to said base plate (17), in order to yield, by convection (CV), the heat generated by said base plate (17) and conveyed, by conduction (CD), towards said dissipators (19), to the airflux (CVF) of the external environment.

7. Public lighting device as claim 1, characterized in that said printed circuit board (20) includes an electronic feeder comprising two power converters (A1, A3-A4), cascade connected, wherein a first input power converter (A1) presents a stage PFC, while a second power converter (A3-A4) is a resonant converter, suitable to drive at high frequency, through a resonant network, at least one isolation transformer (T), an output rectifier and filtering stage (A4) being present downstream said isolation transformer (T), which at the output (U) feeds a plurality of said power-emitting LEDs (24) connected in series, said feeder also including at least one first microcontroller (A6) of management and control of the electrical parameters of the power supply, the electrical parameters and temperature of said power-emitting LEDs (24) and the electrical/electronic parameters of said second resonant power converter (A3-A4).

8. Public lighting device as claim 7, characterized in that said electronic feeder includes at least one second microcontroller (A5), which measures the parameters of said output stage (A4) and send them, by means of devices of interface (OP) and/or serial communication to said first microcontroller (A6).

9. Public lighting device as claim 7, characterized in that said electronic feeder includes at least one radio transceiver (A7), suitable to exchange messages and/or data with external apparatuses and devices.

10. Public lighting device as claim 7, characterized in that said electronic feeder includes at least one low power service feeder (A2), which provides the auxiliary supplies to all the active parts of said lighting device.

11. Public lighting device as claim 7, characterized in that said electronic feeder includes a Doppler effect radar (A8), controlled by said first microcontroller (A6) and suitable to verify the presence and movement of traffic on a roadway.

12. Public lighting device as claim 8, characterized in that the temperature of said power-emitting LEDs (24) is measured by a sensor (NTC), connected with said second microcontroller (A5) and mounted on said base plate (17) of said LEDs (24), which directly measures the temperature of said base plate (17) and, consequently, the junction temperature (Tj) of the LEDs (24).

13. Public lighting device as claim 7, characterized in that the temperature of said power-emitting LEDs (24) is indirectly measured by said electronic feeder by carrying out a measure of voltage between the terminals of at least a plurality of LEDs (24) connected in series and measuring, during the testing phase of said lighting device, the temperature of the environment in which said lighting device is placed, after said lighting device is turned off for a time enough to cool said base plate (17) and said power-emitting LEDs (24), and the voltage between the terminals of said LEDs (24), at the same instant in which said first microcontroller (A6) has turned on said LED (24) through a short pulse.

14. Public lighting device as claim 1, characterized in that said power-emitting LEDs (24) are connected in series within respective strings (S1, S2, S3, S4, S5, S6), independent each other, containing a plurality of LEDs (24) and also connected in series, so as to allow the operation continuity even in case of failure and/or breakage of individual LEDs (24).

15. Public lighting device as claim 14, characterized in that said strings (S1, S2, S3, S4, S5, S6) of LEDs (24) are positioned on said printed circuit board (20) in direction orthogonal to said longitudinal mirrors or reflectors (21).
